(19) United States
(12) Patent Application Publication
(10) Pub. No.: US 2008/0187058 A1
(43) Pub. Date: Aug. 7, 2008

(54) Reduction of dynamic range of transmitted signals

(76) Inventor: Teemu Sipila, Oulunsalo (FI)

Correspondence Address: BRAKE HUGHES BELLERMANN LLP, c/o INTELLEVATE, P.O. BOX 52050, MINNEAPOLIS, MN, 55402, US

(21) Appl. No.: 11/701,237

(22) Filed: Feb. 1, 2007

(51) Int. Cl. H04J 11/00

(52) U.S. Cl. 375/260; 370/210

(57) ABSTRACT

According to an example embodiment, an example technique may include encoding a dataword into a codeword, mapping the codeword to a mapped word, generating a waveform corresponding to the mapped word, and transmitting the generated waveform via a wireless channel. A dynamic range cost function (such as, for example, peak-to-average power ratio (PAPR)) of the waveform corresponding to the mapped word may be less than a dynamic range cost function of a waveform corresponding to the codeword. In this manner, dynamic range of signals may be decreased, for example.

### BACKGROUND

Communication systems often seek to reduce the processing of erroneous data received through a noisy channel by the use of error correcting codes. Error correcting codes or forward error correction (FEC) may typically allow a communication system to detect and/or correct errors in received data by adding redundancy to the transmitted data. Some example codes may include block codes, turbo codes, or convolutional codes, for example.

In addition, high dynamic range may be a problem in many communication systems. High dynamic range may include communicated wireless signals having a relatively high dynamic range cost function, which may be measured or indicated, for example, as peak-to-average power ratio (PAPR) of a signal or waveform, Cubic Metric (CM) of a signal, or other measurement. Relatively high dynamic range may increase linearity requirements for a power amplifier (PA) in the transmitter and for other components. These increased demands may require products to be more complex, and thus, more expensive to accommodate the relatively high dynamic range of transmitted and received signals. Or, if the PA is not linear enough to accommodate the higher PAPR, this may result in lower spectral efficiency of the system due to adjacent channel power leakage, for example. Therefore, techniques are desirable that may decrease the PAPR of a transmitted signal.

### SUMMARY

Various example embodiments are disclosed relating to techniques to reduce the dynamic range of transmitted signals.

One example embodiment may include encoding a dataword into a codeword, mapping the codeword to a mapped word, generating a waveform corresponding to the mapped word, and transmitting the generated waveform via a wireless channel. A peak-to-average power ratio (PAPR) of the waveform corresponding to the mapped word may be less than a PAPR of a waveform corresponding to the codeword.

Another example embodiment may include determining a mapping between each of a plurality of codewords that may be generated by an encoder and a mapped word, mapping a received codeword to a mapped word based on the determining, generating a waveform corresponding to the mapped word, and transmitting the generated waveform via a wireless channel. An average PAPR of waveforms corresponding to the mapped codewords may be less than an average PAPR of waveforms corresponding to the codewords.

According to another example embodiment, an apparatus may include an encoder, a mapper, a waveform generator, and an amplifier. The encoder may be configured to encode a dataword into a codeword. The mapper may be configured to map the codeword into a mapped word. The waveform generator may be configured to generate a waveform corresponding to the mapped word, wherein a PAPR of the waveform corresponding to the mapped word is less than a PAPR of a waveform corresponding to the codeword. The amplifier may be configured to transmit the generated waveform via a wireless channel.

According to yet another example embodiment, an apparatus may include a mapper, a waveform generator, and an amplifier. The mapper may be configured to map a plurality of codewords, which may be generated by an encoder, into a plurality of mapped words, wherein an average PAPR of waveforms corresponding to the mapped codewords may be less than an average PAPR of waveforms corresponding to the codewords. The waveform generator may be configured to generate waveforms corresponding to each of the mapped words. The amplifier may be configured to amplify and transmit the generated waveforms via a wireless channel.

According to another example embodiment, an apparatus for wireless communication may include a controller. The apparatus may be configured to encode a dataword into a codeword, map the codeword to a mapped word, and generate a waveform corresponding to the mapped word, wherein a dynamic range cost function of the waveform corresponding to the mapped word is less than a dynamic range cost function of a waveform corresponding to the codeword, and transmit the generated waveform via a wireless channel.

According to another example embodiment, a method may include encoding a dataword into a codeword, mapping the codeword to a mapped word, generating a waveform corresponding to the mapped word, wherein a dynamic range cost function of the waveform corresponding to the mapped word is less than a dynamic range cost function of a waveform corresponding to the codeword, and transmitting, via a wireless channel, the generated waveform.

The details of one or more implementations are set forth in the accompanying drawings and the description below. Other features will be apparent from the description and drawings.

### BRIEF DESCRIPTION OF THE DRAWINGS

FIG. 1 is a diagram showing a set of possible codewords, codewords, a dataword, and mapped words.

FIG. 2 is a diagram of a transmitter and receiver according to an example embodiment.

FIG. 3 is a flow chart illustrating a method of mapping and transmitting a codeword according to an example embodiment.

FIG. 4 is a flow chart illustrating a method of mapping and transmitting a codeword according to another example embodiment.

FIG. 5 is a block diagram of a transmitter according to an example embodiment.

FIG. 6 is a block diagram illustrating an apparatus that may be provided in a wireless node according to an example embodiment.

### DETAILED DESCRIPTION

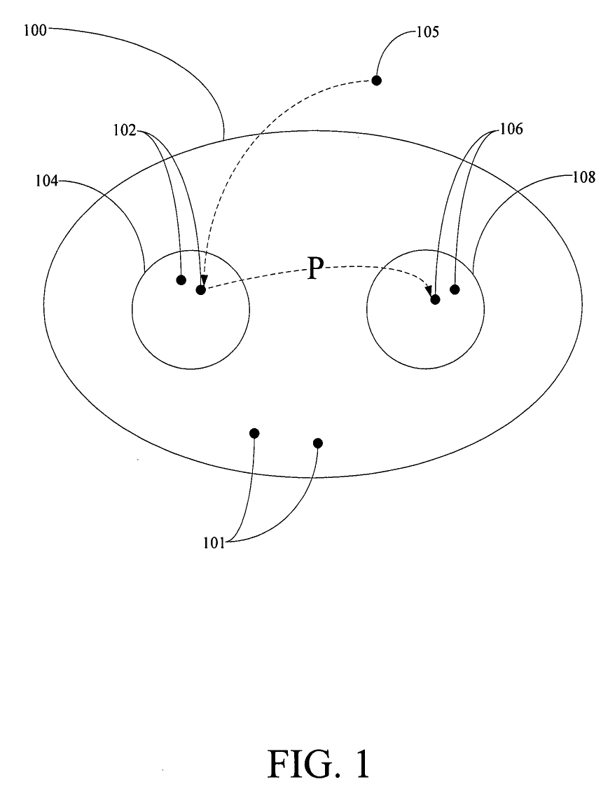

FIG. 1 is a diagram showing a set of possible codewords 100, codewords 102, a dataword 105, and mapped words 106. In some encoding schemes, the set of allowed codewords 104 may include members 101 selected from the set of possible codewords 100 to maximize a Hamming distance between the codewords 102 within the set of allowed codewords 104, and thereby maximize the likelihood of correcting errors. The codewords 102 may each correspond to a dataword 105 according to a coding scheme, for example.

Waveforms corresponding to the codewords 102 may each be considered to have a dynamic range cost function, which may be measured, for example, as a peak-to-average power ratio (PAPR) of the waveform corresponding to each codeword, Cubic Metric (CM) of a signal, or other cost functions or indications of signal dynamic range. In other words, a separate or different waveform, such as a different Orthogonal Frequency Division Multiplexing (OFDM) symbol, may be associated with each codeword. The term PAPR (peak-to-average power ratio) may be used herein to include any of a variety of different dynamic range cost functions. Each waveform or symbol may have a different dynamic range cost function or PAPR. Waveforms for some codewords may have a higher PAPR than waveforms for other codewords. The set of allowed codewords 104 for a given coding scheme may create inefficiencies in a system by including codewords 102 with relatively high PAPRs. The average PAPR for a set of codewords is often undesirably high, since encoders typically do not select codewords or waveforms based on PAPR. If the peak power is limited by, for example, regulatory or application constraints, then the average transmit power may be reduced.

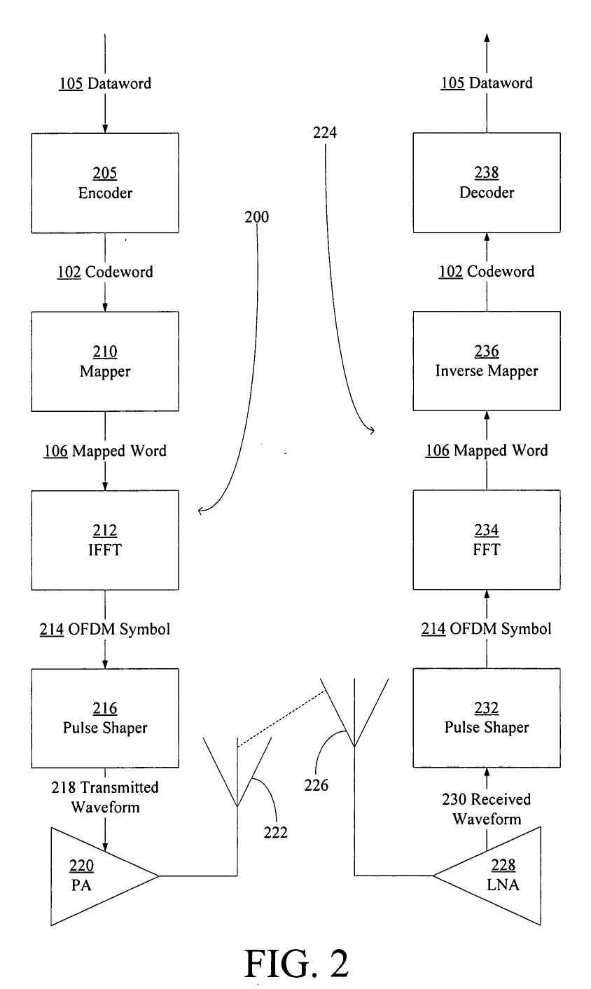

FIG. 2 is a block diagram of a transmitter 200 and a receiver 224 according to an example embodiment. Each wireless device or wireless node may typically include a wireless transceiver that may include both a wireless transmitter 200 and a wireless receiver 204, for example. Such wireless devices or wireless nodes may be provided for use in a wide variety of wireless networks or different technologies, such as cellular networks, wireless LAN (wireless local area network), WiMAX, or other wireless technologies or standards. These are merely a few examples.

Referring to the example embodiment of FIG. 2, transmitter 200 may include an encoder 205 configured to receive a dataword 105. In an example embodiment, the dataword 105 may be a multi-bit number of length k.

The encoder 205 may be configured to encode the dataword 105 into a codeword 102. In an example embodiment, the codeword 102 may also be a be a multi-bit number. The encoder 205 may encode the dataword 102 using any of a number of different encoding schemes, such as block coding, interlaced coding, turbo coding, convolutional coding, etc.

The codeword 102 may have a length n which may be greater than a length k of the dataword 105. The greater length of the codeword 102 may, for example, provide redundancy information to enable detection and/or correction of errors in transmission of the information at a receiver. The codeword 102 may be a member of a set of allowed codewords 104. Each member of the set of allowed codewords 104 may correspond to a possible dataword 105 (in convolutional coding schemes, for example, the dataword to which each allowed codeword corresponds may depend on previous datawords, as an example). The set of allowed codewords 104 may be smaller than a set of possible codewords 100, for example. Different sets of allowed codewords 104 may be possible within a given set of possible codewords 100. These are merely some examples and the embodiments are not limited thereto.

Each codeword 102 from the set of allowed codewords 104 may have a measurable PAPR (or dynamic range cost function) according to a given transmission scheme. For example, in orthogonal frequency division multiplexing (OFDM), each bit (or one or more bits) may be simultaneously transmitted on a subcarrier, depending on the modulation scheme used, such as, for example, binary phase shift keying (BPSK). However, BPSK is merely an example, as any modulation scheme may be used, such as quadrature phase shift keying (QPSK), quadrature amplitude modulation (QAM), or any other modulation scheme.

According to an example embodiment, a mapper 210 may map each codeword to a mapped word. In an example embodiment, a waveform (e.g., OFDM symbol) corresponding to the mapped word may typically have a lower PAPR (or lower dynamic range cost function) than the corresponding codeword. Thus, by using a mapper 210 to map each codeword to a mapped word that may typically have a lower PAPR (or lower dynamic range cost function), this may reduce the PAPR (or reduce the dynamic range cost function) of the transmitted signals, for example. For example, a PAPR may be calculated for each possible codeword, and the lowest PAPR codewords may be selected to be the mapped words 106, for example.

For example, the encoder 205 may only use 1000 of the possible 10,000 codewords (this is merely an example) that could be used. In advance, a computer, a simulator or other program may calculate the PAPR (or dynamic range cost function) of the waveform corresponding to each of the possible 10,000 codewords. The codewords having the lowest, for example, PAPR may be selected as the mapped words 106. A mapping (or map) may be set up within mapper 210 (e.g., stored in memory at a wireless node) that indicates the mapping between each codeword 102 that may be output by encoder 205 and a corresponding mapped word 106 that may typically have a lower PAPR than the codeword 102. For example, one or more (or even all) mapped words 106 may each have a lower PAPR than the corresponding codewords 102, for example. Thus, by transmitting codewords (mapped words 106) having a lower PAPR than the codewords output by encoder 205, a lower PAPR signal may be generated and transmitted, which may allow use of lower complexity and lower cost components, at least in some cases, for example.

In another example embodiment, a set of codewords may be mapped by mapper 210 to a set of mapped words, wherein an average peak-to-average power ratio (PAPR) (or average dynamic range cost function) of waveforms corresponding to the mapped codewords is less than an average PAPR (or average dynamic range cost function) of waveforms corresponding to the codewords. In this manner, the overall (or average) PAPR (or average dynamic range cost function) of the mapped set of words 106 transmitted via wireless medium may have a lower average PAPR (or lower average dynamic range cost function) than an original set of codewords 102. In this example embodiment, each mapped word may have a higher or lower PAPR than the corresponding codeword, but the average PAPR of waveforms of the set of mapped words 106 may be lower than the average PAPR of waveforms of the corresponding set of codewords 102 (e.g., which may be output by encoder 205).

According to yet another example embodiment, although not shown in FIG. 2, encoder 205 and mapper 210 may be combined to provide a low PAPR encoder (or low dynamic range cost function encoder) that may encode a set of data words 105 into a set of low PAPR codewords. In other words, out of the 10,000 possible codewords, low PAPR encoder may be programmed or configured to encode a set of 1000 data words into a set of 1000 low PAPR codewords, where the low PAPR codewords may have relatively low PAPR (relatively low dynamic range cost function) or may even include the 1000 lowest PAPR (or lowest dynamic range cost function) codewords out of the 10,000 possible codewords. Thus, a set of 1000 codewords may be selected, where one or more (or even all), may have relatively low PAPR, or even the lowest PAPR codewords (or lowest dynamic range cost function), for example. Thus, the low PAPR encoder may select and use a set of low PAPR codewords for encoding datawords, for example. This is merely another example embodiment, and many different variations on these examples may be used, for example. Further examples and details will now be provided.

As noted above, the PAPR (or dynamic range cost function) of the waveforms may be calculated or estimated for each codeword 102 from the set of allowed codewords 104 for the transmission scheme. An average PAPR (or average dynamic range cost function) of the set of allowed codewords 104 may also be calculated by summing the PAPRs of the codewords 102 and dividing by the number of codewords 102 in the set of allowed codewords 104. Average PAPRs may be calculated by other methods, such as, for example, summing the squares of each of the PAPRs, dividing by the number of codewords 102, and taking the square root of this value, which would create an “average” PAPR which was more sensitive to outliers, or other techniques. Of course, other measurements may be used for dynamic range cost functions for signals.

Mapper 210 of transmitter 200 may map the codeword 102 to a mapped word 106 selected from a set of mapped words 108. The set of mapped words 108 may be selected from the set of possible codewords 100. Some mapped words 106 in the set of mapped words 108 may also belong to the set of allowed codewords 104, in an example embodiment.

Some members 101 of the set of possible codewords 100 may have lower PAPRs than other members 101 of the set of possible codewords 100. An average PAPR of the set of mapped words 108 may be calculated in a similar manner to calculating the PAPR of the set of allowed codewords 104.

A set of mapped words 108 may be selected which has a lower average PAPR (or lower average dynamic range cost function) than the set of allowed codewords 104 for a given coding scheme. Each mapped word 106 in the set of mapped words 108 may correspond to one codeword 102 in the set of allowed codewords 104, for example. It is possible that a PAPR of one or more of the mapped words 106 in the set of mapped words 108 may have a higher PAPR than the PAPR of their corresponding codewords 102, with the average PAPR of the set of mapped words 104 still being lower than the average PAPR of the set of allowed codewords 104.

In an example embodiment in which the set of allowed codewords 104 has m codewords 102, the PAPR of each member 101 of the set of possible codewords 100 may be calculated, and the m members 101 with the lowest PAPRs may be selected to form the set of mapped words 108. The set of mapped words 108 may have been selected before a given codeword 102 has been received, for example, so that the codeword 102 may be mapped to a predetermined mapped word 106. This mapping from codewords 102 to a set of mapped words 108 may be stored in memory, which may be provided as (or as a part of) mapper 210, for example.

In an example embodiment, codewords 102 from the set of allowed codewords 104 may be mapped to the set of mapped words 108 by multiplying the code word 102 by a permutation matrix P. The permutation matrix P may be a matrix with a number of rows and columns equal to the length of the codeword with only 1's and 0's, and every row and every column may contain one and only one 1. In another example embodiment, at least one of the 1's may be replaced a −1, in which case the permutation matrix P and the mapping will include at least one sign change. The permutation matrix P may also introduce a constant.

An example embodiment may utilize the permutation matrix P which maps a set of allowed codewords 104 to a set of mapped words 108 with a lower average PAPR than the average PAPR of the set of allowed codewords 104, for a given transmission scheme, such as OFDM. The permutation matrix P may be selected so that the average PAPR of the set of mapped words 108 is equal to or lower than an average PAPR of a set of mapped 108 words that could be generated from any other permutation matrix.

In the example embodiment shown in FIG. 2, a mapper 210 maps the codeword 102 to the mapped word 106. The mapper 210 may be retrofitted onto existing devices (e.g., may operate with existing encoders 205 that may not select low PAPR codewords), or may be included as a component of an original equipment manufacture which includes an encoder 205 that uses a predetermined encoding scheme.

The mapper 210 may map between each of a plurality of codewords 102, which may be generated by the encoder 205 and the mapped word 106. The mapper 210 may perform the mapping by, for example, utilizing a lookup table in a database, or by utilizing a permutation matrix P by which to multiply the codeword 102, as some examples. Other techniques may also be used to provide a mapping from codewords 102 to lower PAPR mapped words 106 for transmission. In another example embodiment, mapper 210 may map each of a plurality of codewords 102 to corresponding mapped words 106 so that the average PAPR of the waveforms corresponding to the mapped words 106 is less than the average PAPR of the waveforms corresponding to the codewords 102, for example.

A waveform generator, such as an Inverse Fast Fourier Transformer (IFFT) 212, may generate a waveform corresponding to the mapped word 106. The waveform may, for example, comprise an OFDM symbol 214. In this example, the IFFT 212 may generate the OFDM symbol 214 corresponding to the mapped word 106, wherein a PAPR of the OFDM symbol 214 corresponding to the mapped word 106 may be less than a PAPR of an OFDM symbol corresponding to the codeword 102, for example.

A pulse shaper 216 may, for example, perform pulse shaping operations on the waveform, such as pulse shaping operations within each subcarrier of the OFDM symbol 214 to reduce the intersymbol interference of the subcarriers, or for other purposes. The pulse shaper 216 may transform the OFDM symbol 214 into a transmitted waveform 218.

A power amplifier (PA) 220 may amplify waveform 218 for transmission through an antenna 222. The transmitter antenna 222 may transmit the transmitted waveform 218 to a receiver antenna 226 of the receiver 224 via an air interface (represented by dashed lines). Although transmitter 200 is shown to include an antenna 222, and receiver 224 is shown to include an antenna 226, a receiver and transmitter (e.g., wireless transceiver) at a wireless node may typically employ one antenna for both transmission and reception, for example.

Receiver 224 may receive the transmitted waveform 218 via the receiver antenna 226. In the example embodiment shown in FIG. 2, a low noise amplifier (LNA) 228 of receiver 224 may boost or amplify the desired signal power of the received signal to generate a received waveform 230 (e.g., received OFDM symbol). A pulse shaper 232 may shape the received waveform 230, e.g., back into the OFDM symbol 214. The pulse shaper 232 may output the OFDM symbol 214 to a fast Fourier transformer (FFT) 234, which may perform a Fast Fourier Transform on the OFDM symbol, for example.

FFT 234, which perform a FFT on the OFDM symbol 214 to generate the mapped word 106. FFT 234 may output the mapped word 106 to an inverse mapper 236.

The receiver 224 may include the inverse mapper 236 to map from mapped words 106 to corresponding code words 102. The inverse mapper 236 may map a received mapped word 106 to a corresponding codeword 102, using a same map used by mapper 210, for example. Thus, inverse mapper 236 may map from a low PAPR mapped word 106 to a corresponding codeword used by decoder 238. Thus, inverse mapper 236 may perform the inverse (or reverse) of the mapping performed by mapper 210, for example. Thus, in the same manner as mapper 210, inverse mapper 236 may store a map in memory, such as a lookup table, etc., that may allow inverse mapper 236 to perform the inverse mapping operation, e.g., mapping from low PAPR mapped words 106 to codewords 102.

The inverse mapping of a mapped word 106 to a corresponding codeword 102 may be performed by inverse mapper 236 in a manner similar (e.g., but opposite) to mapper 210. The mapping scheme (or map) used by transmitter 200 may have previously been communicated or provided to the receiver 224 (e.g., and stored in memory). For example, the inverse mapper 236 may perform the inverse mapping by consulting a lookup table from memory, or by utilizing an inverse permutation matrix P⁻¹ (not shown). In the latter example, the inverse mapper 236 may determine the codeword 102 from the mapped word 106 by multiplying the mapped word 106 by the inverse permutation matrix P⁻¹. The inverse permutation matrix P⁻¹ may be an inverse of the permutation matrix P. Other techniques may be used to perform the inverse mapping. The inverse mapper 236 may output the codeword 102 to a decoder 238.

The decoder 238 may decode the codeword 102 back into the corresponding dataword 102 using a technique corresponding to the coding technique used by the encoder 110, such as, for example, block coding, interlaced coding, or convolutional coding. For example, if convolutional coding is used at encoder 205, Viterbi decoding may be used by decoder 238. A wide variety of decoding techniques may be employed at decoder 238. Decoder 238 may generally decode received codewords 102 to obtain the corresponding dataword 105, and may also perform associated error detection and/or correction based on the received codeword 102, for example. The decoder 238 may provide the dataword 102 to another desired component or device, or provide the dataword 102 to an upper layer of software (e.g., being executed by a processor controller, not shown, at the receiver wireless node) for processing.

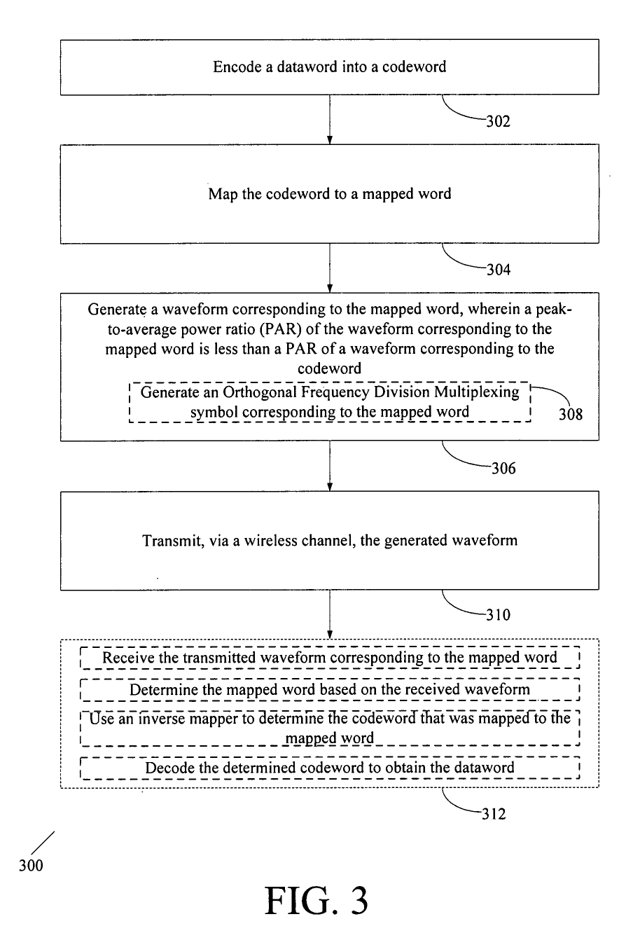

FIG. 3 is a flow chart illustrating a mapping and transmitting a codeword according to an example embodiment. In the example shown in FIG. 3, the dataword 105 may be encoded into the codeword 102 (302). This encoding may be performed by any of a number of encoding schemes, such as block coding, interlaced coding, or convolutional coding, for example. A turbo coder or a convolutional encoder may be used to encode the dataword 105 into the codeword 102, for example.

The codeword 102 may be mapped to the mapped word 106 (304). The codeword 102 may be mapped to the mapped word 106 by, for example, consulting a lookup table or by multiplying the codeword 102 by a permutation matrix P, or using other techniques. The permutation matrix P may be calculated, for example, to minimize (or at least decrease) an average PAPR of members of the set of mapped words 108. The permutation matrix P may include a plurality of, such as at least one, sign change. Other types of permutations matrices may be used, and other techniques may be used to determine a mapping from codewords to mapped words.

A waveform corresponding to the mapped word 106 may be generated (306). A PAPR of the waveform corresponding to the mapped word 106 may be less than a PAPR of a waveform corresponding to the codeword 102 from which the mapped word 106 was mapped. In this manner, a lower PAPR waveform (or symbol) may be generated for wireless transmission, for example.

In an example embodiment, generating the waveform may comprise generating an Orthogonal Frequency Division Multiplexing (OFDM) symbol corresponding to the mapped word 106 (308). A PAPR (or dynamic range cost function) of the OFDM symbol corresponding to the mapped word 106 may be less than a PAPR (or dynamic range cost function) of an OFDM symbol corresponding to the codeword 102 from which the mapped word 106 was mapped. The OFDM symbol may be generated by processing the mapped word 106 by the IFFT 212 to generate the OFDM symbol in the time domain.

The generated waveform may be transmitted via a wireless channel (310). The generated waveform may be amplified and transmitted by, for example, a PA 220 and via the transmitter antenna 222. Transmitting the generated waveform may include pulse shaping and/or amplification, in example embodiments. Other steps or operations, not shown, may also be performed as part of transmitter and/or receiver processing.

The method 300 may also include receiver operations (312), according to an example embodiment. This example may include receiving the transmitted waveform corresponding to the mapped word 106, determining the mapped word 106 based on the received waveform, using the inverse mapper 236 to determine the codeword 102 that was mapped to the mapped word 106, and decoding the determined codeword 102 to obtain the dataword 105.

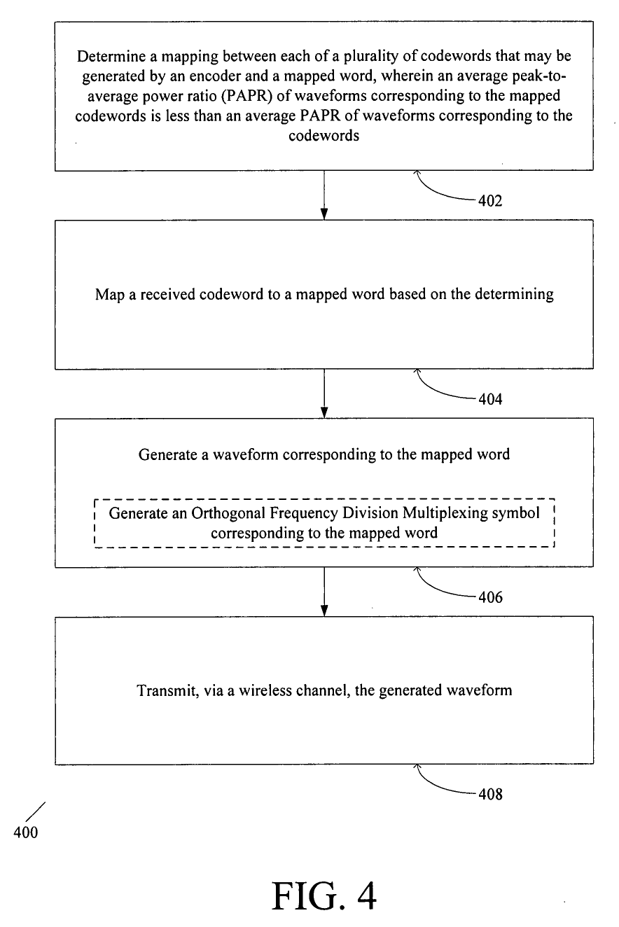

FIG. 4 is a flow chart illustrating a mapping and transmitting a codeword according to an example embodiment. This example may include determining a mapping between each of a plurality of codewords 102 that may be generated by the encoder 205 and the mapped word 106 (402), wherein an average peak-to-average power ratio (PAPR) of waveforms corresponding to the mapped words is less than an average PAPR of waveforms corresponding to the codewords. The mapping may be determined by, for example, measuring a PAPR for each of the possible codewords (or possible mapped words), and selecting a set of codewords as the mapped words, where one or more (or even all) of the mapped words may have a lower PAPR of the corresponding codewords. Or the set of mapped words may have an average PAPR that is lower than the average PAPR of the codewords (e.g., some may have a lower PAPR and some may be higher, but on average, mapped words may have a lower PAPR). Or in another example embodiment, a subset of the codewords may be selected as the mapped words that have the lowest PAPR. A lookup table may be generated and stored. Or, alternatively, the determining may include receiving and/or storing a lookup table or permutation matrix, for example. Other techniques may be used.

A received codeword 102 may be mapped to a mapped word 106 based on the determined mapping (404). The received codeword 102 may be mapped to the mapped word 106 by, for example, generating the mapped word 106 based on the results of a lookup table operation, or by multiplying the codeword 102 by the permutation matrix P, or other mapping technique.

A waveform corresponding to the mapped word 106 may be generated (406). The waveform may be generated by, for example, using a digital signal processor to implement the IFFT 212. In an example embodiment, an OFDM symbol corresponding to the mapped word 106 may be generated, and a PAPR of the OFDM symbol corresponding to the mapped word 106 may be less than a PAPR of an OFDM symbol corresponding to the codeword 102.

The generated waveform may be transmitted via a wireless channel (408). The generated waveform may be amplified and transmitted through, for example, the PA 220 and transmitter antenna 222. In some example embodiments, the transmitting may include shaping a pulse of the generated waveform and/or amplifying the generated waveform. Other operations may also be performed.

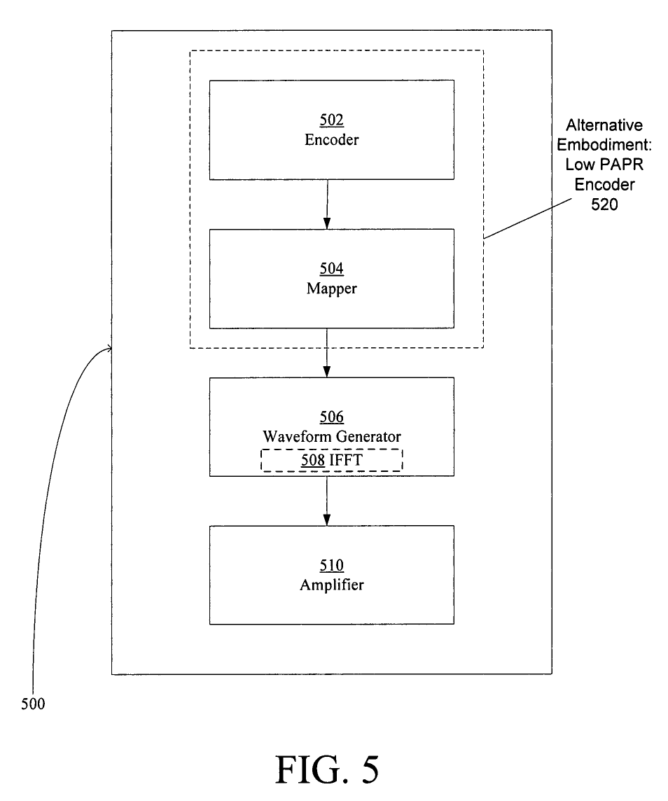

FIG. 5 is a block diagram of a transmitter 500 according to an example embodiment. In this example embodiment, the transmitter 500 includes an encoder 502 configured encode the dataword 105 into the codeword 102. The encoder 502 may encode the dataword 105 into the codeword 102 using any number of coding schemes, such as, for example, block coding, interlaced coding, or convolutional coding. The transmitter 500 may further include a mapper 504 configured to map one or a plurality of codewords 102, which may be generated by the encoder 502, to one or a plurality of mapped words 106. A PAPR of a waveform(s) corresponding to the mapped word(s) 106 may be less than a PAPR of a waveform corresponding to the codeword(s) 102.

The transmitter 500 may further include a waveform generator 506 configured to generate a waveform(s) corresponding to the mapped word(s) 106. The waveform generator 506 may, for example, include an inverse fast Fourier transformer (IFFT) 408 configured to generate the waveform(s) corresponding to the mapped word(s) 106. The transmitter 500 may further include an amplifier 410 configured to transmit the generated waveforms via a wireless channel, such as, for example, an air interface.

Also, in an alternative embodiment, encoder 502 and mapper 504 may be combined as a low PAPR encoder 520, as described above, which may encode datawords into a set of low PAPR code words. Similarly, at receiver 224, a low PAPR decoder may be provided that may decode directly from low PAPR code words into data words.

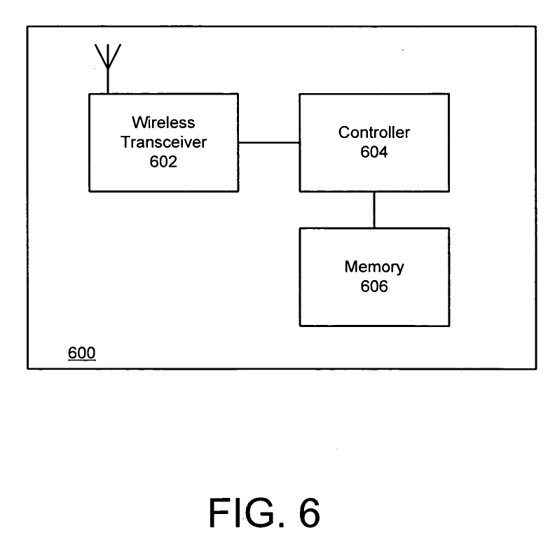

FIG. 6 is a block diagram illustrating an apparatus 600 that may be provided in a wireless node according to an example embodiment. The wireless node (e.g. station or AP) may include, for example, a wireless transceiver 602 to transmit and receive signals, a controller 604 to control operation of the station and execute instructions or software, and a memory 606 to store data and/or instructions.

Controller 604 may be programmable and capable of executing software or other instructions stored in memory or on other computer media to perform the various tasks and functions described above, such as one or more of the tasks, techniques or methods described herein.

In addition, a storage medium may be provided that includes stored instructions, when executed by a controller or processor that may result in the controller 604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art.

What is claimed is:

1. A method comprising:
encoding a dataword into a codeword;
mapping the codeword to a mapped word;
generating a waveform corresponding to the mapped word, wherein a peak-to-average power ratio (PAPR) of the waveform corresponding to the mapped word is less than a PAPR of a waveform corresponding to the codeword; and
transmitting, via a wireless channel, the generated waveform.

2. The method of claim 1 wherein the encoding comprises using a turbo coder to encode a dataword into a codeword.

3. The method of claim 1 wherein the encoding comprises using a convolutional encoder to encode a dataword into a codeword.

4. The method of claim 1 wherein the generating comprises generating an Orthogonal Frequency Division Multiplexing (OFDM) symbol corresponding to the mapped word, wherein a peak-to-average power ratio (PAPR) of the OFDM symbol corresponding to the mapped word is less than a PAPR of an OFDM symbol corresponding to the codeword.

5. The method of claim 4 wherein the generating the OFDM symbol comprises processing the mapped word by an inverse fast Fourier transform (IFFT) to generate the OFDM symbol in the time domain.

6. The method of claim 1 and further comprising:
receiving the transmitted waveform corresponding to the mapped word;
determining the mapped word based on the received waveform;
using an inverse mapper to determine the codeword that was mapped to the mapped word wherein a PAPR of the received waveform corresponding to the mapped word is less than a PAPR of a waveform corresponding to the codeword; and
decoding the determined codeword to obtain the dataword.

7. The method of claim 1 wherein the mapping the codeword to the mapped word comprises multiplying the codeword by a permutation matrix.

8. The method of claim 1 wherein the mapping the codeword to the mapped word comprises multiplying the codeword by a permutation matrix which includes at least one sign change.

9. The method of claim 1 wherein the mapping the codeword to the mapped word comprises multiplying the codeword by a permutation matrix calculated to minimize an average peak-to-average power ratio of members of a set of mapped words.

10. A method comprising:
determining a mapping between each of a plurality of codewords that may be generated by an encoder and a mapped word, wherein an average peak-to-average power ratio (PAPR) of waveforms corresponding to the mapped codewords is less than an average PAPR of waveforms corresponding to the codewords;
mapping a received codeword to a mapped word based on the determining;
generating a waveform corresponding to the mapped word; and
transmitting, via a wireless channel, the generated waveform.

11. The method of claim 10 wherein the generating comprises generating an Orthogonal Frequency Division Multiplexing (OFDM) symbol corresponding to the mapped word, wherein a peak-to-average power ratio (PAPR) of the OFDM symbol corresponding to the mapped word is less than a PAPR of an OFDM symbol corresponding to the codeword.

12. The method of claim 10 wherein the mapping comprises multiplying the received codeword by the permutation matrix.

13. An apparatus comprising:
an encoder configured to encode a dataword into a codeword;
a mapper configured to map the codeword into a mapped word;
a waveform generator configured to generate a waveform corresponding to the mapped word, wherein a peak-to-average power ratio (PAPR) of the waveform corresponding to the mapped word is less than a PAPR of a waveform corresponding to the codeword; and
an amplifier configured to transmit the generated waveform via a wireless channel.

14. The apparatus of claim 13, wherein the waveform generator is configured to generate an Orthogonal Frequency Division Multiplexing (OFDM) symbol corresponding to the mapped word, wherein a peak-to-average power ratio (PAPR) of the OFDM symbol corresponding to the mapped word is less than a PAPR of an OFDM symbol corresponding to the codeword.

15. The apparatus of claim 13, wherein the encoder comprises at least one of a turbo encoder or a convolutional encoder.

16. An apparatus comprising:
a mapper configured to map a plurality of codewords, the codewords may be generated by an encoder, into a plurality of mapped words, wherein an average peak-to-average power ratio (PAPR) of waveforms corresponding to the mapped codewords is less than an average PAPR of waveforms corresponding to the codewords;
a waveform generator configured to generate waveforms corresponding to each of the mapped words; and
an amplifier configured to transmit the generated waveforms via a wireless channel.

17. The apparatus of claim 16, wherein the waveform generator includes an inverse fast Fourier transformer configured to generate the waveforms corresponding to each of the mapped words.

18. An apparatus for wireless communication comprising a controller, the apparatus configured to:
encode a dataword into a codeword;
map the codeword to a mapped word;
generate a waveform corresponding to the mapped word, wherein a dynamic range cost function of the waveform corresponding to the mapped word is less than a dynamic range cost function of a waveform corresponding to the codeword; and
transmit, via a wireless channel, the generated waveform.

19. A method comprising:
encoding a dataword into a codeword;
mapping the codeword to a mapped word;
generating a waveform corresponding to the mapped word, wherein a dynamic range cost function of the waveform corresponding to the mapped word is less than a dynamic range cost function of a waveform corresponding to the codeword; and
transmitting, via a wireless channel, the generated waveform.
